(19) United States
(12) Patent Application Publication
(10) Pub. No.: US 2010/0315506 A1
(43) Pub. Date: Dec. 16, 2010

(54) ACTION DETECTION IN VIDEO THROUGH SUB-VOLUME MUTUAL INFORMATION MAXIMIZATION

(75) Inventors: Zicheng Liu, Bellevue, WA (US); Junsong Yuan, Evanston, IL (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/481,579

(22) Filed: Jun. 10, 2009

(51) Int. Cl. H04N 7/18; G06K 9/62

(52) U.S. Cl. 348/143; 348/E05.062; 382/209

(57) ABSTRACT

Described is a technology by which video is processed to determine whether the video contains a specified action. The video corresponds to a spatial-temporal volume. The volume is searched to find a sub-volume therein that has a maximum score with respect to whether the video contains the action. Searching for the sub-volume is performed by separating the search space into a spatial subspace and a temporal subspace. The spatial subspace is searched for an optimal spatial window using upper-bounds searching. Also described is discriminative pattern matching.

### BACKGROUND

It is relatively easy for the human brain to recognize and/or detect certain actions such human activities within live or recorded video. For example, in a meeting room scenario, it is easy to determine whether someone is walking to a whiteboard, whether someone is trying to show something to remote participants, and so forth. In surveillance applications, a viewer can determine whether there are people in the scene and reasonably judge where there are any unusual activities. In home monitoring applications, video can be used to track a person's daily activities.

It is often not practical to have a human view the large amounts of live and/or recorded video that are captured in commercial and other scenarios where video is used. Thus, being able to automatically distinguish and detect certain actions would benefit from automated processes. However, automatically detecting certain actions within video is difficult and overwhelming for contemporary computer systems, in part because of the vast amounts of data that need to be processed for even a small amount of video.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which video is processed to determine whether the video contains a specified action (or other specified class). The video, which is a set of frames over time and thus corresponds to a three-dimensional volume is searched to find a sub-volume therein that has a maximum score with respect to whether the video contains the action. That sub-volume may then be evaluated as to whether it sufficiently matches the action.

In one aspect, searching for the sub-volume including separating the search space into a spatial subspace and a temporal subspace. The spatial subspace is searched for an optimal spatial window using upper-bounds searching. The temporal subspace for an optimal temporal segment in the temporal subspace that is also within the optimal spatial window.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for detecting actions in videos.

FIG. 2 is representation of a volume formed via a series of two-dimensional images taken over time.

FIG. 3 is representation of a sub-volume within a volume illustrating feature points within the volume.

FIG. 4 is a representation offinding an upper bound while searching for sub-volumes within a volume.

FIG. 5 shows an illustrative example of a computing environment into which various aspects of the present invention may be incorporated.

### DETAILED DESCRIPTION

Various aspects of the technology described herein are generally directed towards more efficiently detecting actions within video using automated processes. to this end, a discriminative pattern matching referred to as naive-Bayes based mutual information maximization (NBMIM) for multi-class action categorization is described, along with a data driven search engine that locates an optimal sub-volume within a three-dimensional video space (comprising a series of two-dimensional frames that taken together in time form a volume).

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in sample labeling and data processing in general.

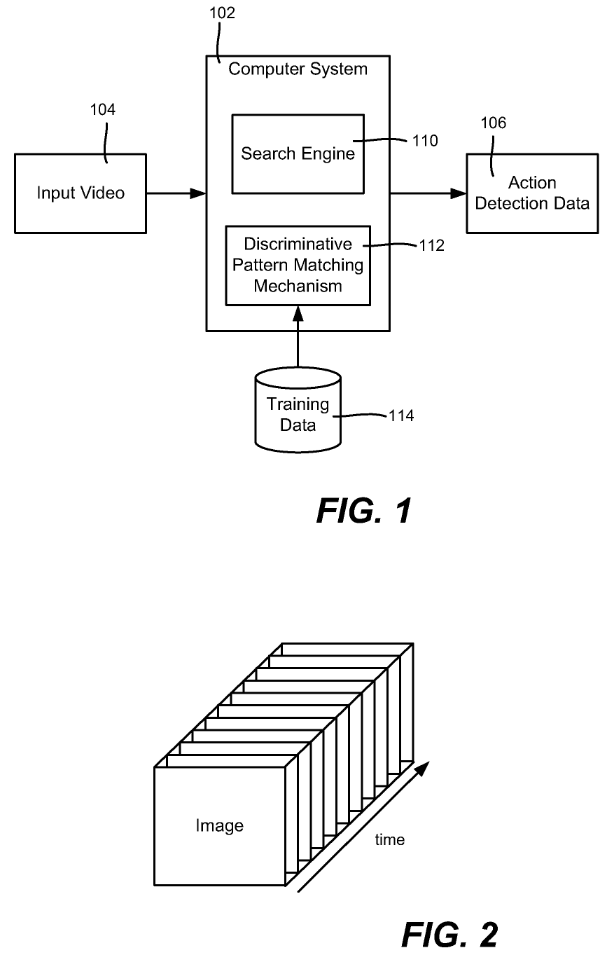

FIG. 1 shows a block diagram in which a computer system 102 processes a set of input video 104 (e.g., in mostly real time or some recorded clip) to determine whether the video 104 may be classified as having a particular action therein, as represented in FIG. 1 by the action detection data 106 (e.g., including a yes/no classification). As will be understood, when detected, the action may be identified with respect to space and time, e.g., a “yes” classification may include information as to when and where the particular action took place.

As represented in FIG. 1 and described herein, the detection is made via components including a search engine 110 and a discriminative pattern matching mechanism 112. The discriminative pattern matching mechanism 112 (e.g., a naïve Bayes mutual information maximization as described below) may be based on training data 114/feature descriptors extracted offline.

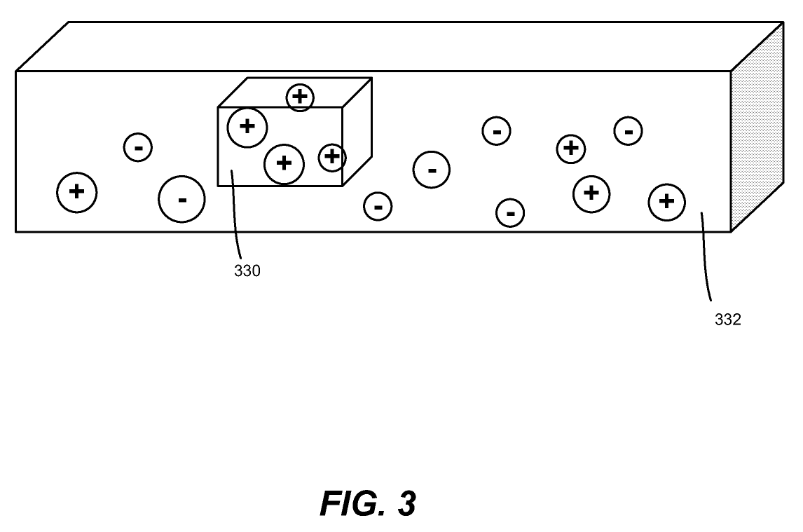

As represented in FIG. 2, a series of images over time form a three-dimensional volume, e.g., any pixel may be identified by a two-dimensional spatial position coordinates and a temporal coordinate. As generally represented in FIG. 3, a sub-volume 330 is a smaller volume within such a volume 332. The technology described herein is directed towards efficiently finding the sub-volume within a volume corresponding to video that most closely matches a specified action class; when found, the video can be classified by that sub-volume. Note that in FIG. 3, action detection searches for a three-dimensional sub-volume that has the maximum mutual information toward the action class; each circle represents a spatio-temporal feature point which contributes a positive or minus vote based on its own mutual information

Spatio-temporal patterns can be characterized by collections of spatio-temporal invariant features. Action detection finds the re-occurrences (e.g. through pattern matching) of such spatio-temporal patterns in video. Actions can be treated as spatio-temporal objects that are characterized as three-dimensional volumetric data. Similar to the use sliding windows in object detection in two-dimensional space, action detection in a video can be formulated as locating three dimensional sub-volumes that contain the target action.

However, searching for actions in the video space is far more complicated than searching for objects in an image space. Without knowing the location, temporal duration, and the spatial scale of the action, the search space for video actions is prohibitive for exhaustive search. For example, a one-minute video sequence of size 160×120×1800 contains more than 1,014 three-dimensional sub-volumes of various sizes and locations.

As also represented in FIG. 3, a video sequence is represented by a collection of spatio-temporal invariant points (STIPs), where each STIP casts a positive or negative-valued vote for the action class, based on its mutual information with respect to the action class. Action detection can then be formulated as the problem of searching for the three-dimensional sub-volume that has the maximum total votes. Such a three-dimensional sub-volume is referred to as having a maximum mutual information toward the action class.

As will be understood, to handle the large search space in three-dimensional video, one implementation described herein decouples the temporal and spatial spaces and applies different search strategies to them to speed up the search. In addition, discriminative matching can be regarded as the use of two template classes, one from the entire positive training data and the other from the negative samples, based on which discriminative learning is exploited for more accurate pattern matching.

Benefits include that the proposed discriminative pattern matching can handle action variations by using a large set of training data instead of a single template. By incorporating the negative training information, the pattern matching has better discriminative power across different action classes. Moreover, unlike conventional action detection methods that require object tracking and detection, described is a data-driven approach that does not rely on object tracking or detection. As the technology does not depend on background subtraction, it can tolerate clutter and moving backgrounds. Further, the search method for three dimensional videos is computationally efficient and is suitable for a real time system implementation.

Thus, an action is represented as a space-time object characterized by a collection of spatio-temporal interest points (STIPs). Somewhat analogous to two-dimensional SIFT image features, STIP is an extension of invariant features to three-dimensional video data. After detecting STIPs, two types of features can be used to describe them, namely histogram of gradient (HOG) and histogram of flow (HOF), where HOG is the appearance feature and HOF is the motion feature. As STIPs are locally invariant for the three-dimensional video, such features are relatively robust to action variations due to the changes in performing speed, scale, lighting condition and cloth.

A video sequence is denoted by V={Iₜ}, where each frame Iₜ comprises of a collection of STIPs, Iₜ={dᵢ}. Note that key-frames in the video are not selected; rather all STIPs are collected to represent a video by V={dᵢ}.

A feature vector d ∈ R^{N} describes a STIP; C={1, 2, . . . ,C} are the class labels. Based on the naive Bayes assumption and assuming independence among the STIPs, the class label Ĉ_{Q} of a query video clip

$$Q = {d}_{q} \{ \begin{matrix}m \\ q = 1\end{matrix} s$$

inferred by the mutual information maximization criterion:

$$\begin{matrix}{\hat{C}}_{Q} = arg {max}_{c} MI ( C = c , Q ) \\ = arg {max}_{c} log \frac{P ( Q \vert C = c )}{P ( Q )} \\ = arg {max}_{c} log \frac{{Π}_{{d}_{q} ∈ Q} P ( {d}_{q} \vert C = c )}{{Π}_{{d}_{q} ∈ Q} P ( {d}_{q} )} \\ = arg {max}_{c} {\sum }_{{d}_{q} ∈ Q} log \frac{P ( {d}_{q} \vert C = c )}{P ( {d}_{q} )} \\ = arg {max}_{c} {\sum }_{{d}_{q} ∈ Q} {s}^{c} ( {d}_{q} ) ,\end{matrix} \qquad ( 1 )$$

where s^{c}(d_{q})=MI(C=c, d_{q}) is the mutual information score for d_{q} with respect to class c. The final decision of Q is based on the summation of the mutual information from all primitive features d_{q} ∈ Q with respect to class c. To evaluate the contribution s^{c}(d_{q}) of each d_{q} ∈ Q. the mutual information is estimated through discriminative learning:

$$\begin{matrix}{s}^{c} ( {d}_{q} ) = MI ( C = c , {d}_{q} ) \\ = log \frac{P ( {d}_{q} \vert C = c )}{P ( {d}_{q} )} \\ = log \frac{P ( {d}_{q} \vert C = c )}{P ( {d}_{q} \vert C = c ) P ( C = c ) + P ( {d}_{q} \vert C \neq c ) P ( C \neq c )} \\ = log \frac{1}{P ( C = c ) + \frac{P ( {d}_{q} \vert C \neq c )}{P ( {d}_{q} \vert C = c )} P ( C \neq c )}\end{matrix}$$

Assuming an equal prior, i.e.

$$P ( C = c ) = \frac{1}{C} ,$$

gives

$${s}^{c} ( {d}_{q} ) = log \frac{C}{1 + \frac{P ( {d}_{q} \vert C \neq c )}{P ( {d}_{q} \vert C = c )} ( C - 1 )} . \qquad ( 2 )$$

From Equation (2), the likelihood ratio test

$$[ \frac{P ( {d}_{q} \vert C \neq c )}{P ( {d}_{q} \vert C = c )} < 1 ]$$

determines whether d_{q} votes positively or negatively for class c. When MI(C=c, d_{q})>0 i.e. likelihood ratio

$$[ \frac{P ( {d}_{q} \vert C \neq c )}{P ( {d}_{q} \vert C = c )} < 1 ] ,$$

d_{q} votes a positive score s_{c}(d_{q}) for the class c. Otherwise if

$$MI ( C = c , {d}_{q} ) \leq 0 , i . e . [ \frac{P ( {d}_{q} \vert C \neq c )}{P ( {d}_{q} \vert C = c )} > 1 ] ,$$

d_{q} votes a negative score for the class c. After receiving the votes from every d_{q} ∈ Q, the final classification decision for Q is made. For the C-class action categorization, C “one-against-all” detectors may be built. The test action Q is classified as the class that gives the largest detection score, referred to as naive-Bayes based mutual information maximization (NBMIM):

$${c}^{*} = arg {max}_{c ∈ \{ 1 , 2 , … , C \}} {\sum }_{d ∈ Q} {s}^{c} ( d ) .$$

To compute a likelihood ratio, denote T^{c+}={Vᵢ} as the positive training dataset of class c, where Vᵢ ∈ T^{c+} is a video of class c. As each V is characterized by a collection of STIPs, the positive training data is represented by the collection of all positive STIPs: T^{c+}={dⱼ}. Symmetrically, the negative data is denoted by T^{c-}, which is the collection of the negative STIPs. To evaluate the likelihood ratio for each d ∈ Q, kernel density estimation is applied based on the training data T^{c+} and T^{c-}. With a Gaussian kernel K(·) and by using a nearest neighbor approximation, the likelihood ratio is:

$$\begin{matrix}\frac{P ( d \vert C \neq c )}{P ( d \vert C = c )} = \frac{\frac{1}{\vert {T}^{c -} \vert} {\sum }_{{d}_{j} ∈ {T}^{c -}} K ( d - {d}_{j} )}{\frac{1}{\vert {T}^{c +} \vert} {\sum }_{{d}_{j} ∈ {T}^{c +}} K ( d - {d}_{j} )} \\ \approx {exp}^{- \frac{1}{2 {σ}^{2}} ( {‖ d - {d}_{NN}^{c -} ‖}^{2} - {‖ d - {d}_{NN}^{c +} ‖}^{2} )} ,\end{matrix}$$

where d_{NN}^{c-} and d_{NN}^{c+} are the nearest neighbors of d in class c− and c+, respectively.

For a Gaussian kernel, an appropriate kernel bandwidth or needs to be used in density estimation. Too large of a kernel bandwidth may over-smooth the density function, while a too small kernel bandwidth only uses the nearest neighbor for the final result. Instead of using a fixed kernel, an adaptive kernel strategy is described, which adjusts the kernel bandwidth based on the purity in the neighborhood of a STIP. For a d ∈ Q. its ε-nearest neighbors in class c are denoted by NN_{ε}^{c+}(d)={dⱼ ∈T^{c+}: ||dⱼ−d||≦ε}. Correspondingly the whole ε-nearest neighbors of d are denoted by NN_{ε}(d)={dⱼ∈T^{c+} ∪ T^{c-}: ||dⱼ−d||≦ε}.

The ε-purity of d is defined by

$${w}_{ε} ( d ) = \frac{\vert {NN}_{ε}^{c +} ( d ) \vert}{\vert {NN}_{ε} ( d ) \vert}$$

As NN_{ε}^{c+}(d) œ NN_{ε}(d), w_{ε}(d) ∈[0,1]. To adaptively adjust the kernel size, 2σ²=1/w_{ε}(d). Denote γ(d)=||d−d_{NN}^{c-}||²−||d−d_{NN}^{c+}||². Based on Equation (2), the adjusted voting score for each STIP for class c is:

$${s}^{c} ( d ) = log \frac{C}{1 + {exp}^{γ ( d ) {w}_{ε} ( d )} ( C - 1 )} \qquad ( 3 )$$

Essentially, w_{ε}(d) describes the purity of the class c in the ε-NN of point d. The larger the w_{ε}(d), the more reliable the prediction it gives, and thus the stronger the voting score sc(d). In the case when d is an isolated point such that |NN_{ε}^{c}+(d)|=|NN_{ε}(d)|=0, it is treated as a noise point and set w_{ε}(d)=0. Thus it does not contribute any vote to the final decision as s^{c}(d)=0 according to Equation (3).

For every STIP d ∈ Q. its nearest neighbors are searched in order to obtain the voting score s^{c}(d). Therefore, a number of nearest neighbor queries need to be performed depending on the size of |Q|. To improve the efficiency of searching for nearest neighbors in the high-dimensional feature space, locality sensitive hashing is applied for the approximate ε-NN search.

Turning to action detection in video via sub-volume mutual information maximization, one task of action detection is to identify where (spatial location in the image) and when (temporal location) the action occurs in the video. Based on the NBMIM criterion, described herein is a formulation of action detection as a sub-volume mutual information maximization problem. Given a video sequence V, the general goal is to find a three-dimensional sub-volume V* ⊂ V that has the maximum mutual information on class c:

$$\begin{matrix}{V}^{*} = arg {max}_{V ⊆ v} MI ( V , C = c ) \\ = arg {max}_{V ⊆ v} {\sum }_{d ∈ V} {s}^{c} ( d ) \\ = arg {max}_{V ∈ Λ} f ( V ) ,\end{matrix} \qquad ( 4 )$$

where

$$f ( V ) = {\sum }_{d ∈ V} {s}^{c} ( d )$$

is the objective function and Λ denotes the candidate set of the valid three dimensional sub-volume s in V. Suppose the target video V is of size m×n×t. The optimal solution V*=t*×b*×l*×r*×s*×e* has 6 parameters to be determined, where t*, b* ∈[0,m] denote the top and bottom positions, l*, r* ∈[0,n] denote the left and right positions, and s*, e* ∈[0, t] denote the start and end positions. Like bounding-box based object detection, the solution V* is the three-dimensional bounding volume that has the highest score for the target action.

However, the total number of the three dimensional sub-volumes s is on the order of O(n²m²t²). Therefore, it is computationally prohibitive to perform an exhaustive search to find the optimal sub-volume V* from among such a large number.

As described herein, an efficient search for the optimal three dimensional sub-volume employs a three-dimensional branch-and-bound solution. To this end, denote by V a collection of three dimensional sub-volumes s. Assume there exist two sub-volumes Vₘᵢₙ and Vₘₐₓ such that for any V ∈ V, Vₘᵢₙ œVœVₘₐₓ. this gives f(V)≦f⁺(Vₘₐₓ)+f⁻(Vₘᵢₙ), where

$${f}^{+} ( V ) = {\sum }_{d ∈ V} max ( {s}^{c} ( d ) , 0 )$$

contains only positive votes, while

$${f}^{-} ( V ) = {\sum }_{d ∈ V} min ( {s}^{c} ( d ) , 0 )$$

contains only negative ones.
We denote the upper bound of f(V) for all V ∈ V by:

\hat{f}(V)=f⁺(Vₘₐₓ)+f⁻(Vₘᵢₙ)≧f(V). (5)

This upper bound essentially replaces a two-dimensional bounding box by a three-dimensional sub-volume, referred to as a naïve three dimensional branch-and-bound solution.

However, compared to two-dimensional bounding box searching, the search of three dimensional sub-volumes is more difficult, because in three dimensional videos, the search space has two additional parameters (start and end on the time dimension) and this increases from four dimensions to six dimensions (6-D). As the complexity of the branch-and-bound grows exponentially in the number of dimensions, the naive branch-and-bound solution is too slow for three dimensional videos.

As described herein, instead of directly applying branch-and-bound in the 6-D parameter space, the technology described herein decomposes it into two subspaces, namely a 4-D spatial parameter space and 2-D temporal parameter space. To this end, W ∈ R²×R² denotes a spatial window and T ∈ R×R denotes a temporal segment. A three dimensional sub-volume V is uniquely determined by W and T. The detection score of a sub-volume

$$f ( {V}_{W \times T} ) is \text{:} f ( {V}_{W \times T} ) = f ( W , T ) = {\sum }_{d ∈ W \times T} s ( d ) .$$

Let W=[0,m]×[0,n] be the parameter space of the spatial windows, and T=[0,t] be the parameter space of temporal segments. The general objective here is to find the spatio-temporal sub-volume having the maximum detection score:

$$[ {W}^{*} , {T}^{*} ] = arg {max}_{W ⊆ 𝕎 \cdot T ⊆ 𝕋} f ( W , T ) \qquad ( 6 )$$

Different search strategies may be taken in the two subspaces W and T and search alternately between W and T. First, if the spatial window W is determined, it is straightforward to search for the optimal temporal segment in space T:

$$F ( W ) = {max}_{T ⊆ 𝕋} f ( W , T ) \qquad ( 7 )$$

This relates to a 1-D max sub-vector problem solved as described below.

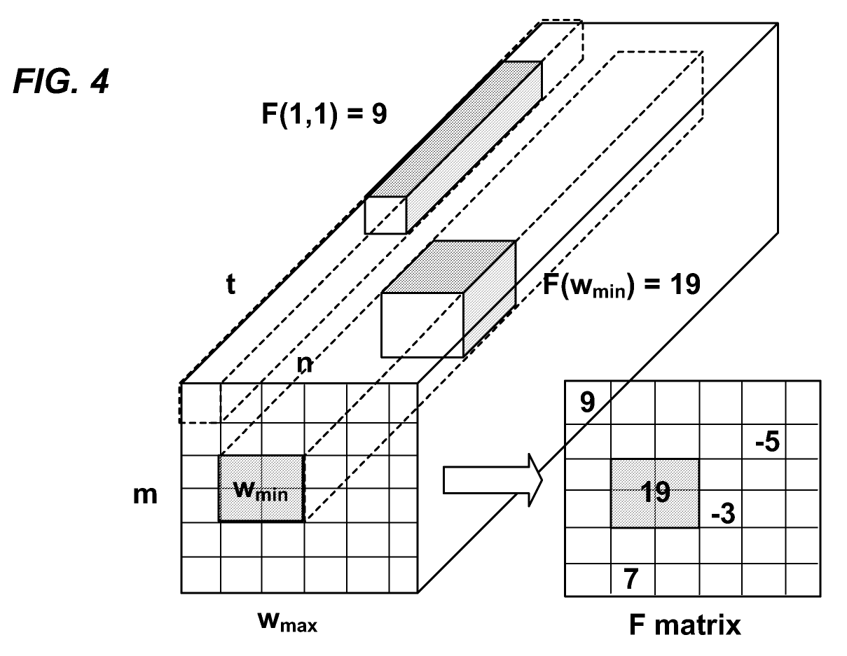

To search the spatial parameter space W, a branch-and-bound strategy is used. Since the efficiency of a branch-and-bound based algorithm depends on the tightness of the upper bound, a tighter upper bound is derived. FIG. 4 illustrates an upper bound; \hat{F}₁=19+9+7=35.

Given an arbitrary parameter space W=[m₁m₂]×[n₁, n₂], we denote by W*=argmax_{W∈ W}F(W) denotes the optimal solution, and denote by F(W)=F(W*). Assume there exist two sub-rectangles Wₘᵢₙ and Wₘₐₓ such that Wₘᵢₙ ⊂ W ⊂ Wₘₐₓ for any W ∈ W. For each pixel i ∈ Wₘₐₓ, denote the maximum sum of the 1D subvector along the temporal direction at pixel i's location by F(i)=max_{T⊂T}f(i,T) Let F⁺(i)=max(F(i), 0) gives the upper bound for F(W), as illustrated in FIG. 4.

$$Lemma 1 ( upper bound {\hat{F}}_{1} ( 𝕎 ) )$$

$$F ( 𝕎 ) \leq {\hat{F}}_{1} ( 𝕎 ) = F ( {W}_{min} ) + {\sum }_{i ∈ {W}_{max} , i ∉ {W}_{min}} {F}^{+} ( i ) . \\ When {W}_{max} = {W}_{min} , \\ we have the tight bound {\hat{F}}_{1} ( 𝕎 ) = F ( {W}_{min} ) = F ( {W}^{*} ) .$$

Symmetrically, for each pixel i ∈ Wₘₐₓ, G(i)=min_{T⊂T}f(i,T) denotes the minimum sum of the 1D subvector at pixel i's location. G⁻(i)=min(G(i), 0) gives the other upper bound for F(W).

$$Lemma 2 ( upper bound {\hat{F}}_{2} ( 𝕎 ) )$$

$$F ( 𝕎 ) \leq {\hat{F}}_{2} ( 𝕎 ) = F ( {W}_{max} ) - {\sum }_{i ∈ {W}_{max} , i ∉ {W}_{min}} {G}^{-} ( i ) . \\ When {W}_{max} = {W}_{min} , \\ we have the tight bound {\hat{F}}_{2} ( 𝕎 ) = F ( {W}_{max} ) = F ( {W}^{*} ) .$$

Based on Lemma 1 and Lemma 2, a final tighter upper bound is obtained, which is the minimum of the two available upper bounds:

Theorem 1(Tighter upper bound \hat{F}(W)) F(W)≦\hat{F}(W)={\hat{F}₁(W), \hat{F}₂(W)} (8)

Based on the upper bound derived in Theorem 1, a branch-and-bound solution in the spatial parameter space W is shown in the following algorithm. As can be seen, unlike the naive three dimensional branch-and-bound solution, the algorithm below keeps track of the current best solution, as denoted by W*. Only when a parameter space W contains a potentially better solution (i.e. \hat{F}(W)>F*) is it pushed into the queue. This avoids a waste of memory and CPU resources in maintaining the priority queue. The algorithm is set forth below:

Alg.1: our new method

```
Require: video ν ∈ R^{m×n×t}
Require: quality bounding function \hat{F} (see text)
Ensure: V* = arg maxv⊂ν f(V)
set W = [T,B,L,R] = [0,n] × [0,n] × [0,m] × [0,m]
get \hat{F}(W) = min{\hat{F}₁(W),\hat{F}₂(W)}
push (W, \hat{F}(W)) into empty priority queue P
set current best solution {W*,F*} = {Wₘₐₓ,F(Wₘₐₓ)};
repeat
retrieve top state W from P based on \hat{F}(W)
if (\hat{F}(W) > F*)
  split W → W¹ ∪ W²
  CheckToUpdate(W₁, W*,F*, P);
  CheckToUpdate(W₂, W*,F*, P);
else
  T* = arg max_{T⊂[0,t]} f(W*,T);
  return V* = [W*,T*].
function CheckToUpdate(W, W*, F*, P)
Get Wₘᵢₙ and Wₘₐₓ of W
if (F(Wₘᵢₙ) > F*)
  update {W*,F*} = {Wₘᵢₙ,F(Wₘᵢₙ)};
if (F(Wₘₐₓ) > F*)
  update {W*,F*} = {Wₘₐₓ,F(Wₘₐₓ)};
if (Wₘₐₓ ≠ Wₘᵢₙ)
  get \hat{F}(W) = min{\hat{F}₁(W),\hat{F}₂(W)}
  if \hat{F}(W) > F*
    push (W,\hat{F}(W)) into P
```

To estimate the upper bound in Theorem 1, as well as to search for the optimal temporal segment T* given a spatial window W, described is an efficient way to evaluate F(Wₘₐₓ), F(Wₘᵢₙ), and in general F(W). According to Eq. 7, given a spatial window W of a fixed size, the process searches for a temporal segment with maximum summation. This problem can be formulated as the 1D max sub-vector problem, where given a real vector of length T, the output is the contiguous subvector of the input that has the maximum sum. The 1D max-sub-vector problem may be solved by in a known way (e.g., by Kadane's algorithm). By applying the trick of integral-image, the evaluation of F(W) using Kadane's algorithm can be done in a linear time.

### Exemplary Operating Environment

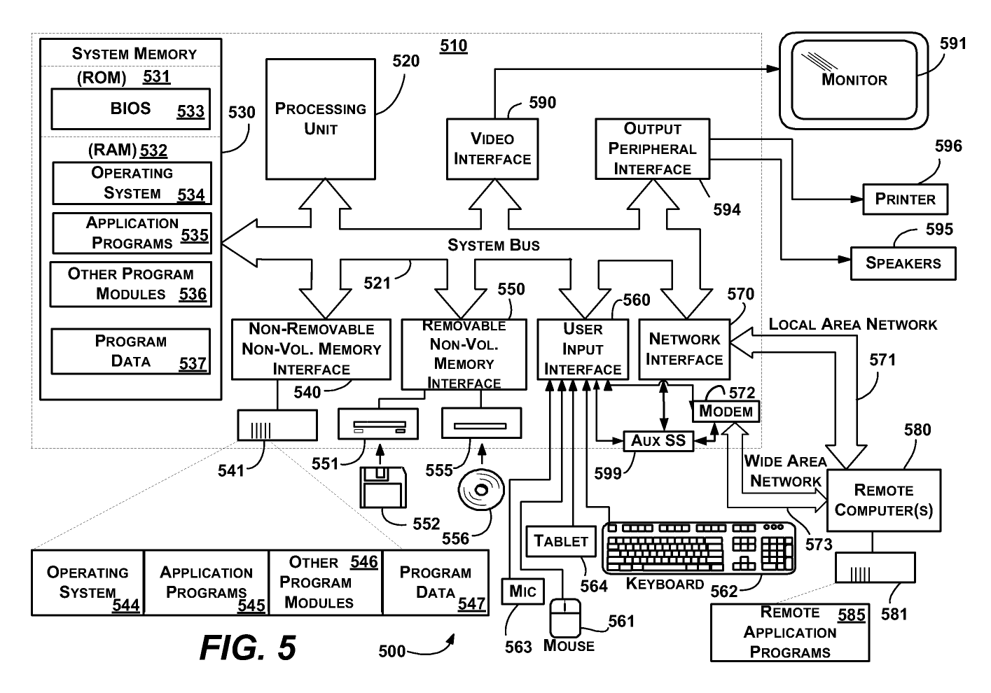

FIG. 5 illustrates an example of a suitable computing and networking environment 500 into which the examples and implementations of any of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, processing a volume corresponding to video to find a sub-volume therein that has a maximum score with respect to a class, including decomposing a parameter space into a spatial subspace and a temporal subspace, searching for an optimal temporal segment in the temporal subspace and searching for an optimal spatial window in the spatial subspace.

2. The method of claim 1 wherein the class corresponds to an action class, and wherein processing the volume detects an action within the video.

3. The method of claim 1 wherein searching for the optimal spatial window in the spatial subspace comprises performing branch-and-bound searching.

4. The method of claim 3 wherein branch-and-bound searching comprises finding an upper bound based on sub-vectors at pixel locations.

5. The method of claim 3 wherein branch-and-bound searching comprises finding two upper bounds based on sub-vectors at pixel locations within sub-rectangles, and selecting an upper bound based on which of the two upper bounds is less than the other.

6. The method of claim 3 wherein branch-and-bound searching comprises finding a best window in a spatial subspace by evaluating two windows with respect to each other and maintaining data as two which window has a better summed feature point score.

7. The method of claim 1 wherein processing the volume to find the maximum score comprises performing discriminative matching using feature points in the volume.

8. The method of claim 7 wherein performing discriminative matching comprises computing a likelihood ratio.

9. The method of claim 7 wherein performing discriminative matching comprises finding nearest neighbors of at least some of the feature points.

10. In a computing environment, a system comprising, a search engine and a pattern matching mechanism that determine whether input video corresponding to a volume contains an action matching a specified action class, the search engine processing sub-volumes within the volume to determine which sub-volume is most likely to contain the action, including by using upper bound searching to identify a smaller subset of a set of available sub-volumes for evaluation.

11. The system of claim 10 wherein the volume corresponds to a search space, and wherein the search engine separates the search space into a temporal subspace and a spatial subspace and uses the upper bound searching on the spatial subspace.

12. The system of claim 10 wherein the pattern matching mechanism performs discriminative matching using feature points in the volume.

13. The system of claim 12 wherein the feature points comprise spatio-temporal interest points, each point providing data indicative of whether that point is more likely or less likely to correspond to the action.

14. The system of claim 12 wherein the pattern matching mechanism includes means for computing a likelihood ratio.

15. The system of claim 12 wherein the pattern matching mechanism includes means for finding nearest neighbors of at least some of the feature points.

16. One or more computer-readable media having computer-executable instructions, which when executed perform steps, comprising, processing a volume corresponding to video to find a sub-volume therein that has a maximum score with respect to whether the video contains an action, including separating a search space into a spatial subspace and a temporal subspace, searching for an optimal spatial window in the spatial subspace, and searching for an optimal temporal segment in the temporal subspace that is also within the optimal spatial window.

17. The one or more computer-readable media of claim 16 wherein searching for the optimal spatial window in the spatial subspace comprises performing branch-and-bound searching, including finding two upper bounds, and selecting a tighter upper bound based on which of the two upper bounds is less than the other.

18. The one or more computer-readable media of claim 16 wherein processing the volume comprises performing discriminative matching using feature points in the volume.

19. The one or more computer-readable media of claim 18 wherein performing discriminative matching comprises computing a likelihood ratio.

20. The one or more computer-readable media of claim 18 wherein performing discriminative matching comprises finding nearest neighbors of at least some of the feature points.
